(19) United States
(12) Patent Application Publication
(10) Pub. No.: US 2023/0264123 A1
(43) Pub. Date: Aug. 24, 2023

(54) SCREENING DEVICE AND METHOD FOR ADJUSTING THE TENSION AT A SCREENING DEVICE

(71) Applicant: Huber SE, Berching (DE)

(72) Inventor: Walter Blomenhofer, Berching/Pollanten (DE)

(21) Appl. No.: 18/011,319

(22) PCT Filed: Jun. 15, 2021
(86) PCT No.: PCT/EP2021/066124

§ 371 Date: Dec. 19, 2022

(30) Foreign Application Priority Data
Jun. 22, 2020 (DE) 10 2020 116 332.0

(51) Int. Cl. B01D 29/44; B01D 29/64; C02F 1/00

(52) U.S. Cl. CPC B01D 29/445; B01D 29/6484; C02F 1/001

(57) ABSTRACT

The invention relates to a method for adjusting the tension of endless and spaced-apart drive elements (1) of a screening device (2), which is used for separating out and removing debris from wastewater (3), wherein the drive elements (1) are moved on a circulating path with the aid of a drive motor (4) of the screening device (2) during the operation of the screening device (2), characterized in that the energy consumption of the drive motor (4) is monitored during the operation thereof, and that the tension is increased as necessary until the energy consumption increases in a previously defined way. Moreover, a screening device (2) for separating out and removing debris from wastewater (3) is provided.

### CROSS REFERENCE TO RELATED APPLICATIONS

The present application claims priority to application Serial No. PCT/EP2021/066124 filed Jun. 15, 2021, which is hereby incorporated herein in its entirety by this reference for all purposes.

### FIELD OF THE INVENTION

The present invention relates to a method for adjusting the tension of endless and spaced-apart drive elements of a screening device, which is used for separating out and removing debris from wastewater, wherein the drive elements are moved on a circulating path with the aid of at least one drive motor of the screening device during the operation of the screening device.

### BACKGROUND OF THE INVENTION

Relevant screening devices are sufficiently known from the related art and are used, for example, for removing coarse screenings (wood, stones, etc.) from wastewater flowing in a sewer. For this purpose, the screening device is generally integrated into the sewer in such a way that the screening surface, starting from the channel bed, extends upward perpendicularly or at a slight slant. In order to enable the screenings retained by the bar screen forming the screening surface to be discharged, the screening surface usually extends above the maximum water level to be expected.

Due to a circulating operation of clearing elements in the form of so-called cleaning rakes assigned to the screening surface, the screenings are subsequently conveyed upward, along the front side of the screening surface, in the direction of a screenings discharge and, there, are removed from the cleaning rake or cleaning rakes, for example, with the aid of a scraper. In order to be able to move the cleaning rakes, relevant screening devices include a drive motor, which is connected to two drive elements extending adjacent to each other, wherein the drive elements in turn are connected to the individual cleaning rakes. If the drive elements are moved on a predefined circulating path with the aid of the drive motor, the cleaning rakes also move on this circulating path and, thereby, along the bar screen.

Such a screening device of the generic type is described, for example, in conjunction with FIG. 1 from DE 10 2012 103 058 A1.

Another screening device of the generic type is disclosed, for example, in DE 10 2004 062 316 A1. The device described therein also includes two drive elements extending in parallel to each other in the form of drive chains, between which in turn a plurality of adjacent screening elements extends. The screening elements each have a screening surface curved toward the outside, by means of which the debris carried in the wastewater is retained. Alternatively and also within the scope of the present invention, screening elements can also be used, which have a screening surface having a flat cross-section or zigzag edges. If the drive elements are moved on their circulating path with the aid of a drive motor, the debris, together with the screening elements, enters an area downstream from the upper return area of the drive elements in the conveying direction and, there, is removed from the screening elements with the aid of a cleaning brush, in order to subsequently enter a collection container, for example, a container, via a screenings discharge. The wastewater, freed from the debris, passes through the screening device and can be routed to its further use. Such screening devices therefore do not have a rigidly positioned bar screen as is the case with the initially mentioned screening device. Rather, in this case, the section that retains the debris carried by the wastewater, i.e., the aforementioned screening elements, is moved on a circulating path. The screening elements are connected on each side to one of the drive elements in this case.

The drive elements lengthen over time due to the tensile forces acting on the drive elements. It is therefore necessary to readjust the tension of the drive elements at regular time intervals, in order to ensure a reliable operation of the particular screening device. The tension is generally adjusted manually and based on empirical values. Such an adjustment is not optimal, however and, therefore, is in need of improvement.

### OBJECTS AND SUMMARY OF THE INVENTION

The problem addressed by the present invention is therefore that of providing a method for adjusting the tension of drive elements of a screening device and an appropriate screening device, which differ from the known related art in a positive way.

The problem is solved by a method and a screening device having the features described below.

The method according to the invention is used for adjusting the tension of endless and spaced-apart drive elements of a screening device. In particular, the screening device has two circulating paths extending in parallel to each other, on which the drive elements are moved during the operation of the screening device (the circulating paths do not need to be physically present; rather, the circulating path refers to the path taken by the drive elements as they move).

The drive elements are preferably connected to individual cleaning rakes or individual screening elements, wherein the drive elements move either the cleaning rakes or the screening elements, depending on the design of the screening device.

The drive elements are, for example, drive chains or drive belts. It is also conceivable that the cleaning rakes or the screening elements are connected on both sides via connecting elements, for example, joints. In this case, the connecting elements can be operatively connected to the drive motor, so that a particular plurality of connecting elements can be considered as one drive element. It is also conceivable that the cleaning rakes or screening elements include, in addition to the connecting elements, outwardly protruding bolts, which are then operatively connected to one drive wheel in each case. A drive element is formed in this case by the connecting elements and the bolts, which are located on the same side of the cleaning rakes or screening elements.

Each drive element therefore preferably includes a plurality of individual elements, which are preferably movable in relation to each other and which then jointly form the particular drive element, wherein individual elements or all individual elements can also be an integral part of individual cleaning rakes or screening elements.

The drive elements are moved with the aid of at least one drive motor of the screening device. The individual drive elements are preferably guided in a lower area and an upper area of the screening device with the aid of a return mechanism in each case, in particular a drive wheel, such as, for example, a sprocket (also referred to as: gearwheel) or a smooth drive wheel without teeth, wherein one of the drive wheels in each case, preferably the upper drive wheel in each case, is driven with the aid of a drive motor. The drive wheels to be driven can be connected to separate drive motors or to a common drive motor via a drive shaft.

The adjustment of the tension according to the invention now takes place as follows (wherein the following description is based on the case that both drive elements, or all drive elements if more than two drive elements are present, are driven by a single drive motor; if multiple drive motors are present, the description applies similarly for one or multiple drive motor(s) of the multiple drive motors):

According to the present invention, the energy consumption of the drive motor is monitored during the operation of the drive motor. The energy consumption is understood to be the amount of electrical energy that the drive motor requires during its operation, the drive motor being designed as an electric motor. The instantaneous energy consumption and/or the energy consumption averaged over a certain period of time can be ascertained, for example, by measuring and/or monitoring the amperage of the current reaching the drive motor. It is also conceivable that the electrical power of the drive motor is monitored. The load angle of the drive motor can also be used as a parameter for the energy consumption.

In any case, the energy consumption is evaluated and, thereby, monitored over a defined period of time, which can be, for example, between 10 seconds and 30 minutes, with the aid of a controller of the screening device. The measured values necessary therefor, such as, for example, the amperage, are provided to the controller preferably via one or multiple sensor(s), which are also intended to be an integral part of the screening device. Of course, the energy consumption can also be monitored over a longer period of time (multiple days up to multiple months) and preferably averaged over the period of time.

Finally, the tension of one or preferably all drive element(s) is increased by a certain amount as necessary (i.e., for example, after a defined period of time after the last increase of the tension, after a defined operating time of the screening device since a previously established event, or under consideration of the previously ascertained energy consumption and/or further parameters). This takes place, in particular, by increasing the spacing of the particular upper and lower drive wheels of a particular drive element. This can be effectuated, for example, by moving the lower drive wheel downward with the aid of a threaded spindle or any other adjusting mechanism in relation to a frame or a frame element of the screening device and/or the upper drive wheel upward with the aid of an appropriate threaded spindle. After the adjustment of the position of the relevant drive wheel or its axis of rotation, the drive wheel or a bearing guiding the axis of rotation is fixed in position again.

It is also conceivable that an adjusting element that includes a gearwheel or a sliding surface is assigned to each drive element, the sliding surface deflecting the relevant drive element. The tension of the drive element also changes depending on how strong this deflection is.

After the tension has been increased or during the increase of the tension, the energy consumption of the drive motor operatively connected to the relevant drive element is ascertained again (wherein the ascertainment is also carried out over a defined period of time, wherein in turn individual measured values related to the energy consumption, such as, for example, the amperage, can be averaged). Of course, the drive motor is activated during the ascertainment of the energy consumption and effectuates a movement of one or multiple drive element(s).

If the energy consumption has increased in a previously defined way (for example, by a certain amount or percentage or up to or over a certain amount), this is seen as an indication that the tension has increased by at least the desired amount. If an appropriate increase is not evident, the tension is increased again by a certain amount. This sequence of increasing the tension and evaluating the possibly resultant increase of the energy consumption is carried out for as long as it takes until an increase of the energy consumption with respect to the energy consumption ascertained at the beginning of the adjustment process is detected, the increase corresponding to previously established specifications.

Due to the monitoring and evaluation of the energy consumption, it can therefore be established whether the increase of the tension was sufficient or whether the tension must be increased further in order to achieve the desired tension.

It is advantageous when the energy consumption is ascertained continuously or at regular time intervals over a period of time of multiple days, preferably of multiple weeks, particularly preferably of multiple months, wherein the tension is increased when the energy consumption has decreased over the course of the period of time in a previously defined way. The reduction of the tension is an indication that the drive elements have lengthened by a certain amount (during the operation of the screening device, a not inconsiderable drive force acts on the drive elements, so that the drive elements extend slightly over time in their longitudinal direction). If the tension decreases by a certain amount or percentage with respect to an amount prior to the aforementioned time period or if the tension decreases to or below a certain amount, this is considered to mean that the drive elements have lengthened to such an extent that an increase of the tension is necessary. The tension is increased in this case as described above.

An advantageous supplementation of the invention provides the following approach: After the above-described increase of the tension, the tension is reduced again by a certain amount and the energy consumption is ascertained again. If it is now established that the energy consumption has decreased again in a previously defined way due to the reduction of the tension, the desired tension has been achieved. However, if the energy consumption does not decrease by the desired amount, the tension is reduced again and the energy consumption is evaluated again. This is repeated for as long as it takes until the energy consumption has decreased in a previously defined way.

The tension can be reduced, for example, manually by an operator, wherein the tension does not need to be reduced by a defined amount. Rather, the operator can reduce the tension by a certain amount based on his or her experience. Thereafter, the energy consumption is evaluated again.

For the rest, it is pointed out here that the screening device can include a controller, with the aid of which the evaluation of the particular energy consumption can be carried out. The controller can provide the operator with an indication, for example, after an evaluation of the energy consumption, regarding whether he/she is to increase, reduce, or maintain the tension, since the correct value has been achieved. It is also conceivable that the screening device has only one display, which displays the instantaneous energy consumption and/or the energy consumption of the drive motor(s) averaged over a certain period of time. The evaluation of the energy consumption to determine whether the tension is to be increased or reduced or has reached its desired value would be up to the operator in this case. For example, it would be conceivable that the operator, after a defined increase of the energy consumption, reduces the tension again only by a certain amount, without thereafter taking the energy consumption into account again.

The background of the method in any case is the knowledge that the energy consumption of the drive motor does not significantly decrease or increase when the tension decreases over time due to the lengthening of the chain. On the other hand, the energy consumption of the drive motor increases significantly if the chain is over-tensioned. Since this would mean an excessively high energy consumption of the screening device and, simultaneously, increased wear of the moving components, a tension that is too high is to be avoided in any case. Simultaneously, however, it is also to be ensured that the tension does not drop below a certain limiting value, since this could also negatively affect the operation of the screening device. The tension is therefore tensioned only to the extent that this results in a defined increase of the energy consumption, i.e., an increase of the energy consumption that is limited to a certain amount, wherein the tension can be subsequently reduced again by a certain extent.

The method according to the invention now ensures that the tension can be adjusted to an amount that is as high as possible, but is still just below an amount that would result in an unintended increase of the energy consumption of the drive motor.

It is particularly advantageous when the tension is reduced again after the aforementioned increase of the energy consumption until the energy consumption decreases again in a previously defined way. In this case, the tension is not arbitrarily reduced by the operator. Rather, the reduction of the energy consumption is used as an indication that the chain is not over-tensioned.

It is also advantageous when the tension is increased until the energy consumption reaches or exceeds a first limiting value. An appropriate limiting value is stored, for example, in the controller of the screening device. It is also conceivable that the screening device merely displays the energy consumption to the operator (for example, on a display) and the operator obtains the appropriate limiting value from a database or an appropriate characteristic curve, for example, provided by the chain manufacturer.

Within the scope of the method, the tension is therefore increased either continuously or in a stepwise manner for as long as it takes until the aforementioned limiting value has been reached or exceeded. Thereafter, the tension is reduced again, wherein the energy consumption is preferably evaluated again during or after the reduction.

It is also advantageous when the tension is reduced until the energy consumption reaches or falls below a second limiting value. The second limiting value can also be stored in the controller and automatically taken into account by the controller. Alternatively, the limiting value is known to the operator, wherein the energy consumption that was ascertained after the reduction of the tension is compared by the operator to the appropriate limiting value.

It is also advantageous when the tension is reduced until the energy consumption has decreased again to the energy consumption ascertained prior to the increase. As mentioned above, the energy consumption of the drive motor changes negligibly when the chain lengthens over time. The energy consumption therefore remains quasi constant until the tension is increased to a certain value. The energy consumption prior to the increase of the tension can therefore be used as a reference value. If the energy consumption increases after the tension is increased, this is an indication that the selected tension was too high. If such an increase of the energy consumption is recognized by the operator or by the controller, the tension is reduced again to the point at which the energy consumption had decreased to the reference value. This finally yields an optimal adjustment of the tension.

Moreover, it is advantageous when the tension is increased in a stepwise manner, and, after each increase, the energy consumption of the drive motor is measured and evaluated to determine whether the energy consumption has increased. In fact it is also possible that the energy consumption is measured during the change in the tension and is analyzed according to the preceding description. Generally, however, the drive motor(s) must be stopped before the tension can be changed. In this case, it is advantageous to always change the tension only by a previously defined amount, to subsequently reactivate the drive motor(s), and to ascertain and evaluate the energy consumption. If the energy consumption deviates too greatly from a previously defined limiting value, the drive motor(s) is/are stopped again and the tension is changed again.

It is also advantageous when the tension is also reduced in a stepwise manner, and, after each reduction, the energy consumption of the drive motor is measured and evaluated to determine whether the energy consumption has decreased. The drive motor(s) is/are preferably initially stopped in this case as well. Thereafter, the tension is reduced by a certain amount and the drive motor(s) is/are subsequently restarted. After the restart, the energy consumption is ascertained and evaluated again. If a reduction of the energy consumption corresponding to a defined specification (for example, in the form of the aforementioned limiting value) is not detected, the tension is reduced again.

It is also advantageous when the tension is increased and/or reduced manually. Each drive element is preferably guided by at least two drive wheels. The spacing of the drive wheels can be adjusted, for example, with the aid of a threaded spindle, which can be actuated by an operator with the aid of a suitable tool.

It is particularly advantageous, however, when the increase and/or decrease of the tension takes place with the aid of a tensioning device of the screening device, which is operated automatically and as a function of the particular measured energy consumption with the aid of a controller of the screening device. For example, the aforementioned threaded spindle could be operatively connected to an electric motor, so that the threaded spindle rotates in one direction or the other due to the activation of the electric motor, thereby changing the spacing between the drive wheels of a drive element. The threaded spindle engages, for example, into a thread of a mounting of a drive wheel, so that a rotation of the threaded spindle effectuates a movement of the mounting of the drive wheel and, thereby, also of the drive wheel itself.

It is also advantageous when the method for adjusting the tension is carried out automatically at defined time intervals by the controller and with the aid of the tensioning device. For example, the controller could be designed to switch into an adjustment mode from a normal operating mode, in which the wastewater is freed from debris, at defined time intervals. The method according to the invention is carried out in this adjustment mode, wherein the change of the tension is effectuated with the aid of the aforementioned tensioning device. The screening device therefore automatically adjusts the tension of its drive elements from time to time, so that a reliable and low-wear operation of the screening device is ensured also over a long period of time. A manual intervention during the adjustment of the tension is therefore not absolutely necessary.

It is also extremely advantageous when the method is initiated manually by an operator. It would therefore be conceivable that the adjustment of the tension takes place automatically due to the method according to the invention and with the aid of the controller and of the tensioning device. The adjustment process does not take place automatically at regular time intervals, however, as described above. Rather, the tension is automatically adjusted only when the adjustment process is manually started by the operator, for example, via an input panel of the screening device. The advantage of an operating mode of this type is that the operator generally can very precisely decide, based on his or her experience due to observing the screening device, when the tension must be readjusted. Adjustment processes that are actually not necessary are avoided as a result.

Moreover, a screening device for separating out and removing debris from wastewater is provided, wherein the screening device includes at least two drive elements, which are endless and spaced-apart and, in particular, arranged in parallel, and which are movable on a circulating path with the aid of a drive motor of the screening device during the operation of the screening device.

The screening device is distinguished by the fact that the screening device includes a controller, which is designed for evaluating the energy consumption of the drive motor to determine whether the energy consumption increases in a previously defined way when the tension is increased and/or whether the energy consumption decreases in a previously defined way when the tension is reduced. The screening device is therefore suitable for enabling the tension of the drive elements to be adjusted according to the preceding description. In particular, the screening device includes one or multiple sensor(s), with the aid of which the energy consumption of the drive motor(s) can be detected. A controller should also be present, with the aid of which the signals of the sensor(s) can be evaluated.

It is particularly advantageous when the screening device has at least one screening system that includes movable components for removing debris from the wastewater, wherein the movable components are connected to the two drive elements, so that the movable components are moved together with the drive elements along the circulating path when the drive elements are moved with the aid of the drive motor. The movable components can be, for example, cleaning rakes, which are each simultaneously connected to a drive element. When the drive elements are moved on their circulating path with the aid of the drive motor(s), the cleaning rakes are also moved.

The screening device preferably includes a bar screen, with the aid of which debris of the wastewater to be cleaned can be retained. The cleaning rakes are guided along the bar screen during the operation of the screening device and pick up debris retained by the bar screen. Due to the movement of the cleaning rakes, the debris is subsequently removed from the bar screen and can be guided out of the screening device via a screenings discharge.

It is also conceivable that the screening device includes movable components in the form of individual screening elements, which in turn are connected to the drive elements. The screening elements are used similarly to the aforementioned bar screen for retaining debris that is carried by the wastewater. If the drive elements are moved with the aid of the drive motor(s), the screening elements are also moved and subsequently, in an upper area of the screening device, enter the operating range of a cleaning brush, which removes the debris from the screening elements.

It is also advantageous when the screening device includes a signaling unit, with the aid of which an operator of the screening device may be signaled that the energy consumption of the drive motor has increased in a previously defined way after the tension was increased and/or the energy consumption of the drive motor has decreased in a previously defined way after the tension was reduced. The signaling unit can include, for example, a display or an indicator light. With the aid of the signaling unit, the operator can subsequently recognize whether he/she must further increase or further reduce the tension after an initial increase. It is also conceivable that the signaling unit provides the operator with an indication regarding the amount by which the tension is to be changed.

It is also advantageous when the screening device includes a tensioning device, which is designed for increasing or reducing the tension of the drive elements. Preferably, each drive element is guided about a lower drive wheel and an upper drive wheel. The tensioning device preferably includes elements, with the aid of which the spacing of the drive wheels of a drive element can be changed. The elements are preferably operatively connected to a mounting of the axis of rotation of the upper drive wheels. The elements can include, for example, one or multiple threaded spindle(s) or also one or multiple electric motor(s), with the aid of which the spatial position of the mounting can be changed.

It is also advantageous when the tensioning device is operatively connected to the controller, wherein the controller is designed for increasing the tension by actuating the tensioning device, within the scope of adjusting the tension, until the energy consumption of the drive motor increases in a previously defined way. The controller should also be designed for subsequently reducing the tension again by actuating the tensioning device until the energy consumption decreases again in a previously defined way. The tension can be changed in a stepwise manner or continuously and with constant consideration of the instantaneous energy consumption.

Moreover, it is pointed out that the physical features mentioned in conjunction with the method according to the invention can also be implemented in the screening device according to the invention. Similarly, method features, which have been described in conjunction with the screening device, are implemented within the scope of the initially mentioned method according to the invention. Finally, it is pointed out that the features also mentioned in the following description of the figures can be part of the method according to the invention or of the screening device according to the invention individually or in any combination.

### BRIEF DESCRIPTION OF THE DRAWINGS OF EXEMPLARY EMBODIMENTS

Further advantages of the invention are described in the following exemplary embodiments, wherein, schematically:

FIG. 1 shows a side view of a screening device according to the invention,

FIG. 2 shows a top view of another screening device according to the invention,

FIG. 3 shows a side view of an alternative embodiment of the screening device shown in FIG. 1, and

FIG. 4 shows a side view of another screening device according to the invention.

### DETAILED DESCRIPTION OF EXEMPLARY EMBODIMENTS OF THE INVENTION

It should be noted at the outset that, in figures that show multiple components or sections (such as, for example, cleaning rakes 11) of the same kind, only one of multiple components or sections of the same kind is provided with reference characters for the sake of clarity.

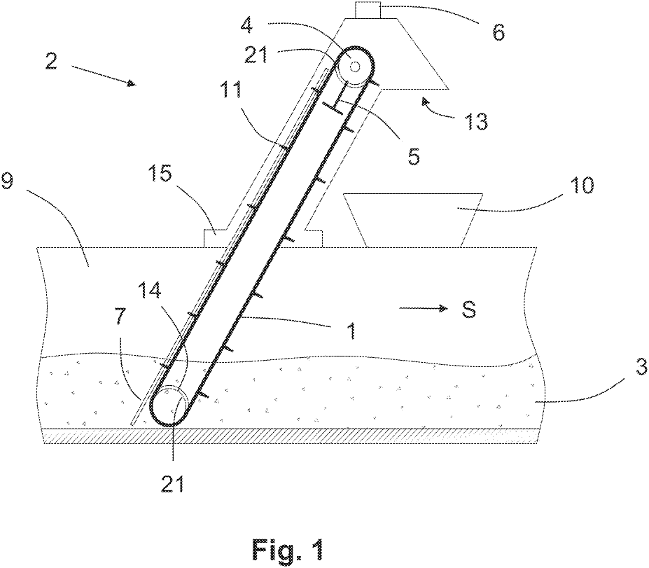

FIG. 1 shows a screening device 2 (in the form of a so-called screening rake in this case) according to the invention integrated into a sewer 9 for separating out and removing debris 17 in the form of screenings (for example, rocks, branches, etc.), wherein the debris 17 is not shown in all figures. The screening device 2 includes a bar screen 7 protruding into the wastewater 3 obliquely from above, the bar screen 7 being connected, for example, by fastening elements (not shown), to the sewer bed, the lateral wall of the sewer, and/or a frame 15 of the screening device 2.

Purely for the sake of completeness, it is pointed out that the screening device 2 can also include a bar screen 7, of course, which is installed into the sewer 9 having been rotated by 90° from the view shown in FIG. 1. The wastewater 3 in this case is laterally deflected with respect to the flow direction S and flows through the bar screen 7 obliquely with respect to the actual flow direction S.

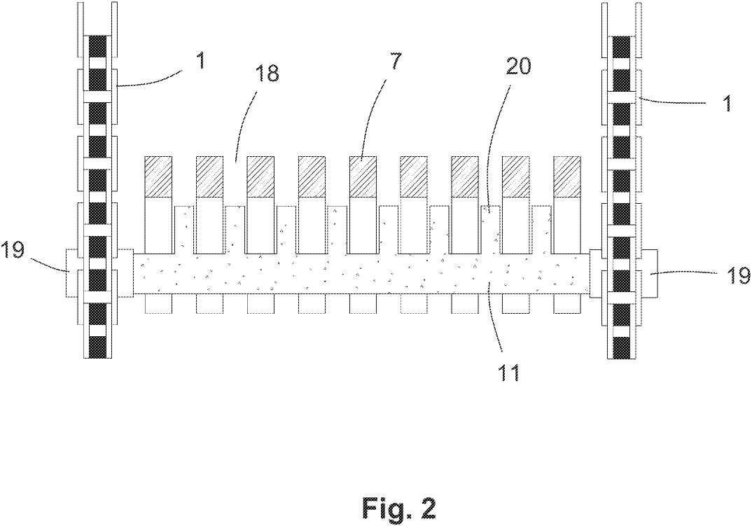

Moreover, the screening device 2 has two drive elements 1, which are arranged one behind the other with respect to the sheet plane shown in FIG. 1, are spaced apart from each other, and are movable in a circulating manner on a circulating path with the aid of a drive motor 4, the drive elements 1 preferably being in the form of drive chains or drive belts, which are connected to one another via multiple intermediate cleaning rakes 11 (only one cleaning rake 11 may possibly also suffice). A top view of a section of the bar screen 7 (cut through) and the drive elements 1 (also shown only in sections) connected to the cleaning rakes 11 is shown in FIG. 2. The cleaning rakes 11 are connected to each of the drive elements 1 by, for example, a mounting 19.

The drive elements 1 are guided on their circulating path via lateral guides (not shown), wherein the guidance can be located in the upper and the lower return areas, but also in the intermediate areas, in which the drive elements 1 extend in parallel to each other. The return areas are preferably each formed by one lower drive wheel 21 and one upper drive wheel 21, which are mounted at the frame 15 of the screening device 2 via appropriate axes of rotation. The drive wheels 21 (for example, in the form of sprockets) are not shown separately. The drive wheels 21 are located, however, in the area of the lower return mechanism 14 and in the area of the drive motor 4 arranged in the upper area.

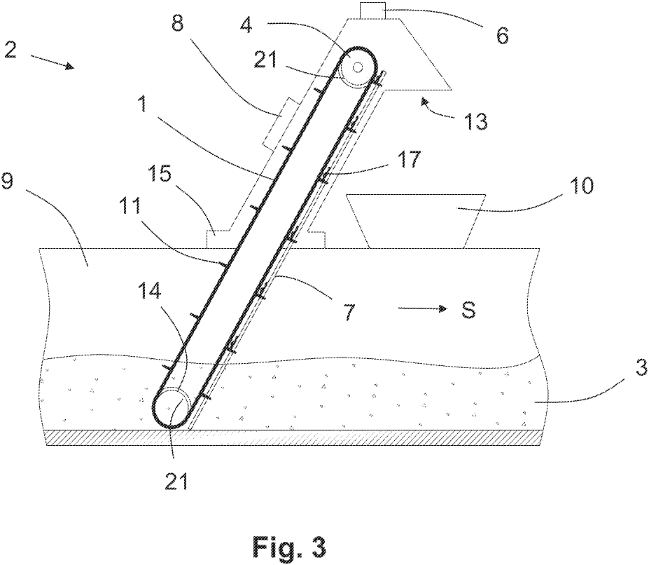

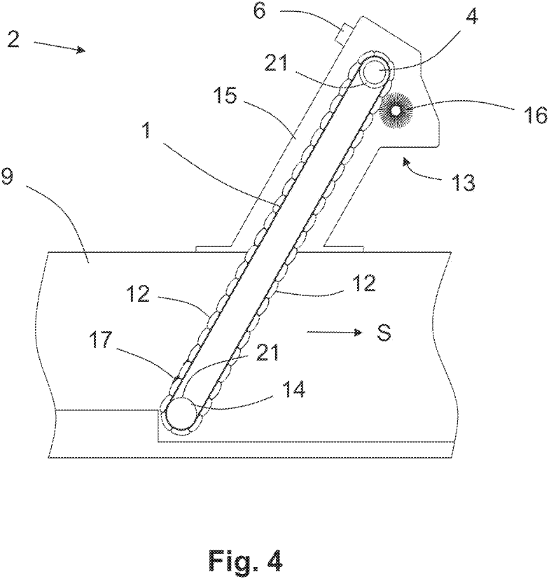

Each cleaning rake 11 includes in turn a plurality of adjacently arranged cleaning prongs 20 (see FIG. 2), which engage into the intermediate spaces 18 of the bar screen 7 when the cleaning rake 11 passes across the upstream-facing front side of the bar screen 7 due to the driving of the drive elements 1 in the conveying direction (in the clockwise direction with respect to FIGS. 1 and 4 and in the counterclockwise direction with respect to FIG. 3).

The screenings retained by the bar screen 7 (the flow direction of the wastewater extends from left to right in FIGS. 1, 3, and 4) are subsequently captured by the cleaning rakes 11 and their cleaning prongs 20 and conveyed upward. After passing through the upper return area, the screenings enter the area of a screenings discharge 13 and, from there, are discharged to the outside, for example, into a container 10. The cleaning rake 11 is subsequently guided back to the lower return area in the area of the lower return mechanism 14, so that the circuit can start over from the beginning.

As shown in FIG. 3, the bar screen 7 does not necessarily need to be combed through by the cleaning rakes 11 from the back (as viewed in the flow direction of the wastewater 3). The embodiment shown in FIG. 3 is also conceivable, in which the bar screen 7 is combed through “from the front.” The embodiments shown in FIGS. 1 and 3 represent merely possible embodiments of the screening device 2 according to the invention.

Another embodiment is shown in FIG. 4. In contrast to the embodiments according to FIGS. 1 and 3, the section that retains the debris 17 of the wastewater 3 is not rigidly arranged in this case, but rather is movably arranged. A plurality of screening elements 12 extending perpendicularly to the sheet plane of FIG. 4 extend between the two drive elements 1, each of the screening elements 12 being connected on both sides to the drive elements 1 and each preferably including an outwardly directed and outwardly curved screening surface section. Alternatively, screening elements 12 can also be used, which include screening surface sections having a flat cross-section or zigzag edges. The screening surface section can be formed, for example, by a metal surface that is appropriately bent and has a plurality of screen openings. The sum of the individual screening surface sections forms the screening surface of the screening device 2.

During the operation of the screening device 2, the drive elements 1 are each guided on an endless circulating path, for example, via two upper drive wheels 21 arranged in parallel to each other and two lower drive wheels 21 also arranged in parallel to each other, the drive wheels being rotatable about appropriate axes of rotation, wherein the movement of the drive elements 1 can take place with the aid of a drive motor 4 (for example, an electric motor) arranged, for example, in an upper return area.

During the screening process, the wastewater 3 can pass through the screen openings of the screening elements 12, while the debris 17 carried by the wastewater 3 is retained by the screening elements 12. The screening elements 12 and, thereby, also retained debris 17, after having passed through the upper return area, enter the operating range of a cleaning brush 16, with which the debris 17 is scraped off the screening elements 12.

The debris 17 removed from the screening elements 12 subsequently reaches the outside via the screenings discharge 13 and can be collected, for example, in an appropriate collection container (not shown).

In all embodiments, it is now important that the tension of the drive elements 1, i.e., the tension that acts on the individual chain links, is adjusted to a correct value.

As is to be derived from FIG. 1 by way of example, a tensioning device 5 is provided for this purpose, with the aid of which the spacing between an upper drive wheel 21 and a lower drive wheel 21 (both of which are assigned to a common drive element 1) can be adjusted. For example, it would be conceivable in this context that the two upper drive wheels 21 are connected to the drive motor 4 via a common drive axle. The drive axle is mounted at the frame 15 with the aid of bearings. If the bearings are now rigidly connected, with the aid of threaded spindles at a counter bearing, to counter bearings connected to the frame 15, the bearings, if they are appropriately movably mounted, can be moved due to the movement of the threaded spindles in the direction of the lower drive wheel 21 or in the opposite direction. As a result, it is possible to adjust the spacing of the two upper drive wheels 21 with respect to the two lower drive wheels 21 and, thereby, change the tension.

Preferably, the tensioning device 5 includes an electric motor, with the aid of which the spacing between the aforementioned drive wheels 21 can be adjusted, for example, by turning the aforementioned threaded spindles.

Moreover, the screening device 2 includes a controller 6, with the aid of which the drive motor 4 and, if present, the aforementioned electric motor, is/are activatable and deactivatable or is/are regulatable with respect to its/their rotational speed.

Moreover, the screening device 2 includes one or multiple sensor(s) (not shown), with the aid of which the energy consumption of the drive motor 4 can be detected. For example, the sensor can be designed to detect the amperage of the current reaching the drive motor 4.

According to the invention, it is now provided that the controller 6 is designed for actuating the tensioning device 5 as a function of the energy consumption of the drive motor 4. In particular, an appropriate chain tensioning mode should be stored in the controller 6, which is activated either manually by an operator or automatically at regular time intervals by the controller 6.

Within the scope of the chain tensioning mode, the instantaneous energy consumption of the drive motor 4 is now initially registered by the controller 6 during a defined period of time. Thereafter, the spacing between the two drive wheels 21 is increased by a certain extent with aid of the tensioning device 5, as the result of which the tension is increased. Thereafter, the energy consumption is detected again and evaluated to determine whether the energy consumption has increased in a previously defined way as compared to the original energy consumption (for example, whether the energy consumption has reached or exceeded a certain limiting value). If this is not the case, the tension is increased again by a certain amount.

As soon as the energy consumption has increased in the previously defined way after an increase of the tension, this is an indication for the controller 6 that the tension was increased by too great of an extent. The controller 6 now prompts the tensioning device 5 to reduce the tension again by a certain extent. After the tension has been reduced, the energy consumption is re-evaluated by the controller 6. If the reduction of the tension effectuates a defined reduction of the energy consumption, the adjustment of the tension is ended. On the other hand, if the energy consumption does not decrease in the desired way after the tension has been changed, the tension is reduced again by a certain extent until the desired energy consumption has been reached.

Alternatively to an automatic adjustment of the tension, it can also be provided that the screening device 2 indicates to the operator, merely with the aid of a signaling unit 8, that the tension must be increased or reduced. Thereafter, the operator changes the tension with the aid of the tensioning device 5, which is then preferably manually actuatable. Subsequently, the energy consumption is re-evaluated, whereupon the controller 6 signals to the operator with the aid of the signaling unit 8 whether the adjustment of the tension has ended, or whether the tension must be further increased or reduced. The tensioning device 5 and the signaling unit 8 are both shown merely in one of the exemplary embodiments. Of course, the tensioning device 5 and the signaling unit 8 can also be present individually or in combination in the remaining exemplary embodiments.

The present invention is not limited to the represented and described exemplary embodiments. Modifications within the scope of the claims are also possible, as is any combination of the described features, even if they are represented and described in different parts of the description or the claims or in different exemplary embodiments, provided no contradiction to the teaching of the independent claims results.

List of reference characters

| | |
|---|---|
| 1. | drive element |
| 2. | screening device |
| 3. | wastewater |
| 4. | drive motor |
| 5. | tensioning device |
| 6. | controller |
| 7. | bar screen |
| 8. | signaling unit |
| 9. | sewer |
| 10. | container |
| 11. | cleaning rake |
| 12. | screening elements |
| 13. | screenings discharge |
| 14. | return mechanism |
| 15. | frame |
| 16. | cleaning brush |
| 17. | debris |
| 18. | intermediate space |
| 19. | mounting |
| 20. | cleaning prong |
| 21. | drive wheel |
| S | flow direction |

1. A method for adjusting the tension of a plurality of endless and spaced-apart drive elements of a screening device, which is used for separating out and removing debris from wastewater, wherein the plurality of endless and spaced-apart drive elements are moved under tension on a circulating path with the aid of at least one drive motor of the screening device during the operation of the screening device, the method comprising the following steps:
monitoring the energy consumption of the drive motor during the operation of the drive motor to move the plurality of endless and spaced-apart drive elements on a circulating path;
monitoring the tension of the plurality of endless and spaced-apart drive elements; and
increasing the tension of the plurality of endless spaced-apart drive elements as necessary until the energy consumption of the drive motor increases in a previously defined way.

2. The method of claim 1, wherein the energy consumption is monitored continuously or at regular time intervals over a period of time of multiple days, and wherein the tension is increased when the energy consumption has decreased over the course of the period of time in a previously defined way.

3. The method of claim 1, wherein the tension is reduced again after the energy consumption has increased.

4. The method of claim 3, wherein the tension is reduced again after the aforementioned increase of the energy consumption until the energy consumption decreases again in a previously defined way.

5. The method of claim 1, wherein the tension is increased until the energy consumption reaches or exceeds a first limiting value.

6. The method of claim 1, wherein the tension is reduced until the energy consumption reaches or falls below a second limiting value.

7. The method of claim 1, wherein the tension is reduced until the energy consumption has decreased again to the energy consumption ascertained prior to the increase.

8. The method of claim 1, wherein the tension is increased in a stepwise manner, and, after each increase, the energy consumption of the drive motor is measured and evaluated to determine whether the energy consumption has increased.

9. The method of claim 1, wherein the tension is reduced in a stepwise manner, and, after each reduction, the energy consumption of the drive motor is measured and evaluated to determine whether the energy consumption has decreased.

10. The method of claim 1, wherein the tension is increased and/or reduced manually or with the aid of a tensioning device of the screening device, which is operated with the aid of a controller of the screening device automatically and as a function of the particular measured energy consumption.

11. The method of claim 10, wherein the method for adjusting the tension is carried out automatically at defined time intervals by the controller and with the aid of the tensioning device.

12. The method of claim 1, wherein the method is initiated manually by an operator.

13. A screening device for separating out and removing debris from wastewater, the screening device comprising:
at least two endless and spaced-apart drive elements, which are movable on a circulating path with the aid of at least one drive motor of the screening device during the operation of the screening device;
a drive motor configured and disposed to drive the at least two endless and spaced apart drive elements in a circulating path;
a controller, which is designed for evaluating the energy consumption of the drive motor to determine whether the energy consumption increases in a previously defined way when the tension is increased and/or whether the energy consumption decreases in a previously defined way when the tension is reduced.

14. The screening device of claim 13, wherein the screening device has at least one screening system that includes movable components for removing debris from the wastewater, wherein the movable components are connected to the at least two endless and spaced-apart drive elements, so that the movable components are moved along the circulating path together with the at least two endless and spaced-apart drive elements when the at least two endless and spaced-apart drive elements are moved with the aid of the drive motor.

15. The screening device of claim 13, wherein the screening device includes a signaling unit, with the aid of which an operator of the screening device may be signaled that the energy consumption of the drive motor has increased in a previously defined way after the tension was increased and/or the energy consumption of the drive motor has decreased in a previously defined way after the tension was reduced.

16. The screening device of claim 13, further comprising a tensioning device, which is designed for increasing or reducing the tension of the drive elements.

17. The screening device of claim 16, wherein the tensioning device is operatively connected to the controller, wherein the controller is designed for increasing the tension by actuating the tensioning device within the scope of the adjustment of the tension until the energy consumption of the drive motor increases in a previously defined way, and wherein the controller is designed for subsequently reducing the tension again by actuating the tensioning device until the energy consumption decreases again in a previously defined way.
